(19) United States
(12) Patent Application Publication
(10) Pub. No.: US 2013/0099721 A1
(43) Pub. Date: Apr. 25, 2013

(54) COMBINATION ENERGY STORAGE SYSTEM FOR SOLAR, WIND AND OTHER "NON-DISPATCHABLE" ENERGY SOURCES SERVING VARIABLE LOADS IN VARIOUS CONDITIONS

(71) Applicants: Moneer Azzam, Wellesley, MA (US); Graham Sayers, Framingham, MA (US)

(72) Inventors: Moneer Azzam, Wellesley, MA (US); Graham Sayers, Framingham, MA (US)

(21) Appl. No.: 13/612,557

(22) Filed: Sep. 12, 2012

Related U.S. Application Data
(60) Provisional application No. 61/626,215, filed on Oct. 21, 2011.

(51) Int. Cl. H02J 7/00

(52) U.S. Cl. 320/101

(57) ABSTRACT

A compound energy storage system made up of two energy storage devices of different characteristics. The first device is a deep cycle lithium ion battery (or similar characteristics) and the second device is deep cycle lead-acid battery (or similar). Both devices are connected in parallel with control circuitry that manages the charging/discharging of each device in such a way that maximizes lifetime of the combined energy storage system when powering a load. First device acts as primary power source and is cycled daily under normal conditions. Second device provides additional power for periods of extended power draw and low temperatures, when the first device is unable to deliver sufficient energy or unable to take a charge. Excess power from external energy source or reserved in one of the devices shall be used to power components that will control device temperature and optimize overall performance of the storage system.

### CROSS-REFERENCE TO RELATED APPLICATIONS

Provisional Patent Application titled “Lithium Ion Based Primary Battery with Lead-Acid Secondary Battery” application Ser. No. 61/626,215 with filing date of Oct. 21, 2011.

A compound energy storage system made up of two energy storage devices of different characteristics, where the first device has characteristics the same as or similar to a large format deep cycle lithium ion batteries and the second device has characteristics the same or similar to deep cycle lead-acid battery. The first device is capable of deep discharges from 50% to 100% for two to five thousand cycles while the 2nd device can only deliver the same number of cycles at discharge levels on the order of 10% to 30%. The first device may be incapable of taking a charge at below 0° C., while the second device can receive a charge at lower temperatures. Both devices are connected in parallel with control circuitry that manages the charging and discharging of each storage device in such a way that maximizes the reliability and lifetime of the combined energy storage system when powering a given load. The first device is the primary source of power and is cycled daily under normal, above freezing conditions. The second device provides additional power for periods of extended power draw and below freezing temperatures, when the first storage device is unable to deliver sufficient energy or is unable to charge. Excess power from external energy source (e.g. solar panel, wind mill) or already stored in one of the energy storage devices, not required for the load at that time, can be used to power components that will heat or cool the energy storage devices to optimize overall performance of the energy storage system.

### FIELD OF THE INVENTION

This invention relates to control methodologies for a Lithium-Ion Based (LIB), or an energy storage device with similar characteristics, used as the “Primary Battery” or “1^{st} Energy Storage Device” and a Lead-Acid Based (LAB), or an energy storage device with similar characteristics, used as the “Secondary Battery” or “2^{nd} Energy Storage Device” to deliver maximum battery life in energy systems that use Solar, Wind and Other Non-Dispatchable Energy Sources to charge the energy storage system and serve variable loads in various conditions.

### BACKGROUND OF THE INVENTION

A grid-independent solar power system typically comprises of a solar panel, energy storage device, and a load, or set of loads that are managed/served by a controller. Many commercial/industrial/professional grid-independent solar power systems are designed for 20 year or longer lifetime. The major component affecting “Total Cost of Ownership” is the energy storage device. Lead acid based batteries have been the technology of choice for many years because they provide a large amount of energy storage at a low cost with good round trip efficiency and good service life. A well designed sealed, maintenance-free or Valve Regulated Lead Acid VRLA battery system can get 5-7 years of life from such a battery. Compared to Lead Acid batteries, Li-ion battery technology, (particularly the Lithium-Ion Iron Phosphate Technology for larger power applications such as lighting) requires no maintenance, offers longer lifetime and allows very deep discharge without major compromise to the overall battery lifetime. However, it has two significant drawbacks; 1) Its price and 2) it cannot take a charge if the battery is below freezing. This invention employs the strength of the Li-ion battery in a grid-independent system in such a way where its weaknesses are mitigated.

### BRIEF SUMMARY OF THE INVENTION

This invention is based on using Lithium-Ion based battery (LIB) or other batteries that exhibit similar cycling and lifetime characteristics, also referred to as “1st Energy Storage Device” in this application and a Valve Regulated Lead Acid (LAB) battery (or other batteries that exhibit similar lifetime characteristics), also referred to as “2nd Energy Storage Device” along with a control circuit to make up an energy storage sub-system for solar lighting and other grid-independent applications. The LIB (1st Energy Storage Device) will get the daily cycling, while the LAB (2nd Energy Storage Device) acts as the standby for above average electrical loads and longer periods of inclement weather. Based on analysis, this configuration should produce a 10 to 12 year maintenance-free (e.g. no water filling) battery at lowest total cost of ownership. One embodiment of the invention is one Lithium Ion Iron Phosphate (LIB) battery in the range of 40 amp-hours at C/100 (capacity at 100 hour discharge rate) for every sealed Valve Regulate Lead Acid (LAB) battery in the range of 120 amp-hour at C/100 discharge rate. The charging algorithm will be more complex, in that unlike the LAB batteries, the LIB should not receive a trickle or float charge and it typically cannot receive a charge at less the 0° C. Both batteries will have to be monitored and controlled separately. U.S. Pat. Nos. 5,670,266, 6,517,972 and US Publication's US 2003/0160510 and US 2009/0317696 are incorporated herein with this reference.

The invention is to create a control system that employs both Li-Ion (LIB) and Lead Acid (LAB) battery in a synergistic format. This would be particularly effective in solar lighting systems, where the load increases with longer nights while at the same time the amount of solar charge available decreases as the days correspondently shorten. In this concept, the LIB battery would be selected to serve the daily routine load for the bulk of the year. The LIB is not as adversely affected as other battery technologies when it is deep-cycled to 100% of its capacity. The LAB battery would act as a standby for the LIB battery in cases of prolonged inclement weather or the load is on for an excessive amount of time, such as the case of a solar light, where the light is on for 15 or 16 hours of the day (in more northern or southern latitudes) around the solstice. In this case the LAB battery would only be cycled rarely.

As an example, FIGS. 1 and 2 compare a sample LIB-LAB combination system with a conventional LAB system. The “Combination System” packs a total rated capacity of 151 amp-hrs of energy storage, and on average, cycles the LIB to 50% Depth of Discharge (DoD), while the LAB may only be cycled on average 10% or less. This compares to a conventional Lead Acid system that must pack a rated capacity of 222 Amp-hours of energy to provide the same amount of no sun autonomy. This is because the LAB battery cannot be 100% deep-cycled without permanent damage. In solar powered systems the typical control system disconnects the load at about 75% DoD. On the other hand, the LIB battery can be discharged to 100% without permanent damage. In this example the LAB batteries in the conventional system are cycled closer to 25% DoD, which has a much more adverse affect on lifetime as shown in FIG. 1.

### BRIEF DESCRIPTION OF THE SEVERAL VIEWS OF THE DRAWING

Other objects, features and advantages will occur to those skilled in the art from the following description of a preferred embodiment and the accompanying drawings, in which:

FIG. 1 is a chart comparing a 1^{st} Energy Storage Device and 2^{nd} Energy Storage Device (LIB-LAB) combination system with a conventional LAB;

FIG. 2 is a table comparing a 1^{st} Energy Storage Device and 2^{nd} Energy Storage Device (LIB-LAB) combination system with a conventional LAB;

FIG. 3 is a chart of a first sample scenario illustrating 1^{st} Energy Storage Device and 2^{nd} Energy Storage Device (LIB-LAB) operation, with 1^{st} Energy Storage Device Priority Charging;

FIG. 4 is a chart of a second sample scenario illustrating 1^{st} Energy Storage Device and 2^{nd} Energy Storage Device (LIB-LAB) Charging operation, with 2^{nd} Energy Storage Device Priority Charging;

FIG. 5 is a chart of a second sample scenario illustrating LIB-LAB PWM charging transfer

FIG. 6 is writing a diagram of a 1^{st} Energy Storage Device and 2^{nd} Energy Storage Device (LIB-LAB) set up;

FIG. 7 is a block diagram of 1^{st} Energy Storage Device and 2^{nd} Energy Storage Device (LIB-LAB) Combination set up;

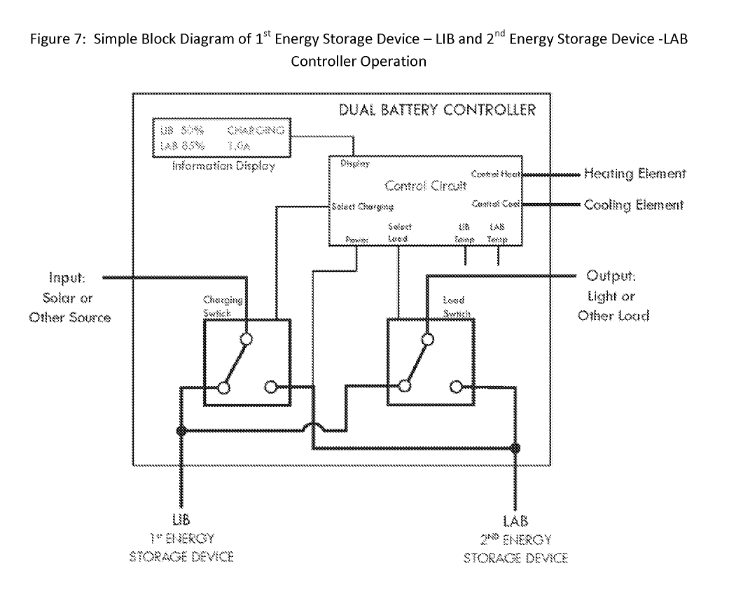

FIG. 8 is a flow chart depicting first example charging prioritization for 1^{st} Energy Storage Device and 2^{nd} Energy Storage Device (LIB-LAB) combination system, 1^{st} Energy Storage Device (LIB) Priority Charging.

FIG. 9 is a flow chart depicting a second example charging prioritization for 1^{st} Energy Storage Device and 2^{nd} Energy Storage Device (LIB-LAB) combination system, 2^{nd} Energy Storage Device (LAB) Priority Charging and

FIG. 10 is a simple flow chart depicting load management base on LIB/LAB battery state of charge.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not limited to that embodiment. Moreover, the claim is hereof are not to be read restrictively unless there is clear and convincing evidence manifesting a certain exclusion, restriction, or disclaimer.

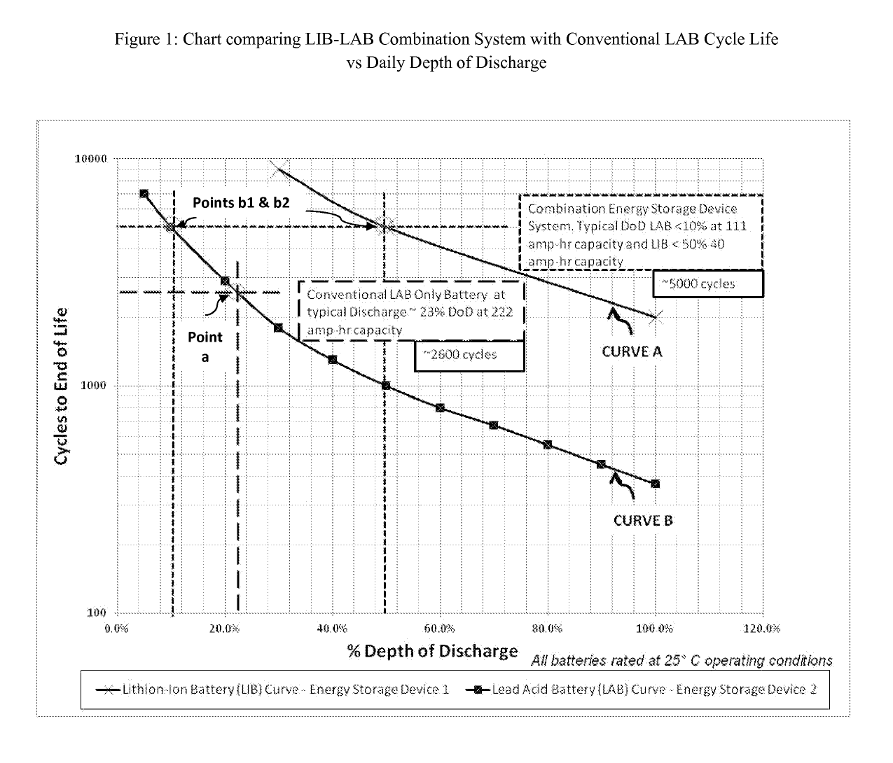

The chart in FIG. 1 compares representative life cycle curves between the characteristics of 1^{st} Energy Storage Device and 2^{nd} Energy Storage Device intended in this invention. In this case Curve A depicts a typical relationship between % depth of discharge and cycle life for a Lithium Ion Battery type (LIB) or Energy Storage Device 1, while Curve B depicts the same relationship for a Lead Acid Battery (LAB) or Energy Storage Device 2. Cycle life is defined as number of cycles to end of battery life, which in turn is defined as the point that the battery has lost greater than 30% of its energy storage capacity. To illustrate the lifetime advantages of this LIB-LAB Combination invention some comparative points are identified in the chart. Point (a), identified by the intersection of the long dashes, might represent a typical depth of discharge in a Lead Acid battery (LAB) of 23%. The resultant cycle life, at 25° C., is on the order of 2,600 cycles. Whereas points (b1) and (b2), indentified by the intersections of the short dashes, represent a corresponding cycle life of 5,000 cycles, serving an equivalent load by applying a depth of discharge value on the 1^{st} Energy Storage Device (LIB) on the order of 50% while the 2^{nd} Energy Storage Device (LAB) is only discharged on the order of 10%.

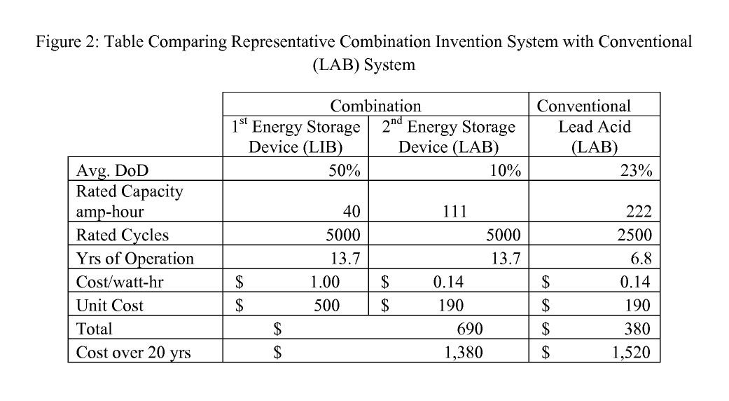

The table in FIG. 2 is representative of relative sizing capacity and potential equipment cost implications the scenario depicted in FIG. 1. In order to understand the battery sizing capacity advantage in this invention, it's important to understand sizing of a conventional LAB solution. In the case of the LAB, the rated battery capacity is higher than the available battery capacity. Low temperatures reduce available capacity of a LAB. A controller's “Low Voltage Disconnect” (LVD) feature also reduces available LAB capacity.

The formulas below establish the rated LAB capacity for a given number of days of storage. The days of storage is specified as a design criterion. Databases such as NASA's climate database have recommended days of storage for solar power systems for different locations around the world. Days of storage for a given system is calculated as the total available capacity divided by the average daily load, determined by the following formula D=LABₐᵥₐᵢₗ/LOAD_{avg}. Therefore the required LAB capacity would be the product of the days of storage and the average load or LABₐᵥₐᵢₗ=D*LOAD_{avg}. In order to determine the rated LAB capacity, one takes into account temperature and LVD factors with the following formula. LAB_{rated}=LABₐᵥₐᵢₗ/(T_{derate}*(1−LVD))
LAB_{rated}=nominal lead-acid battery capacity in watt-hrs, usually at 20 hr rate
LABₐᵥₐᵢₗ=available lead-acid battery capacity in watt-hrs
LOAD_{avg}=average daily load in watt-hrs
D=days of storage
T_{drerate}=derating of battery due to temperature, given as a percentage, e.g. 90%
LVD=SOC where LVD activates, typically 25%
   For example a 1000 watt hour rated battery, with LVD set to 25% SOC operating in an environment where temperature cuts the battery capacity to 90% would have an available capacity of 675 Whrs. If the required “days of storage” was 6.75 days then the average daily load would be 100 watt hours.

FIG. 2 shows a relative rated capacity decrease of 32% (from 222 amp-hours to 151 amp-hours) in going from a conventional LAB approach to the combination approach. It also indicates almost two LAB replacements for every one of the combination battery systems over the lifetime of the system. This advantage should result a meaningful reduction in the “total cost of ownership” in systems with cyclical and varying loads, such as stand-alone solar lighting systems.

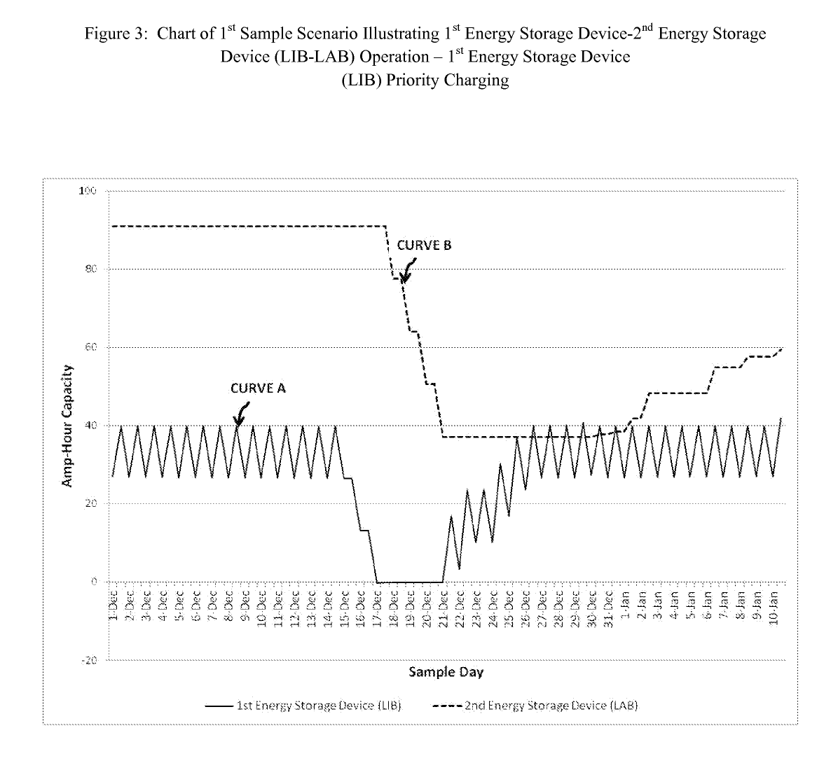

FIG. 3 depicts the first approach to operation of the LIB-LAB Combination system by looking at the available amp-hour capacity of each battery type. Curve A represents the 1^{st} Energy Storage Device (LIB) while the 2^{nd} Energy Storage Device is represented by the Curve B with the dashed line. This example assumes that the system is located in the Northern Hemisphere and the period of time in the chart covers the winter solstice when the night is longest and the day is shortest. This is the period of time that the load is the greatest and the amount of available sunlight to charge the batteries is the lowest. Consequently the batteries are most likely to be drawn down to their lowest state of charge during this time. In this example the 1^{st} Energy Storage Device (LIB) is regularly cycled on a daily basis to roughly 60% state-of-charge between December 1 and December 14. But between December 15 and December 22 the weather is extremely poor and the batteries receive no charging whatsoever. During this time, the 1^{st} Energy Device (LIB) battery is completely depleted by December 17. The system then switches over to the 2^{nd} Energy Device (LAB) battery and continues to deplete that battery until December 22, at which point the weather improves and the days start getting longer. The 2^{nd} Energy Storage Device (LAB) battery is depleted to about 35% state of charge. In this first example the 1^{st} Energy Storage Device (LIB) receives the priority for available charge. Only until it reaches full charge does the system start charging the 2^{nd} Energy Storage Device (LAB).

There is a second method where recharging of the batteries follows a more complex protocol that first requires an understanding of how each battery technology is optimally charged. LAB batteries have 3 basic charging stages, bulk, equalization and float. Bulk charging is required when the LAB battery is below 85% SOC. In this case the battery can accept a high rate of current and charges quickly. During the equalization and float stages, the current to the LAB battery tapers off to a “trickle charge” or “float charge” in order to “top off” the battery. The LIB battery, for all intents and purposes, receives a bulk charge for most of the charging process. Once fully charged, the LIB battery cannot receive a trickle charge or it will be damaged, while the LAB battery benefits from a trickle charge. With these characteristics in mind, the charging protocol for the dual LIB/LAB battery system is disclosed as follows: If the LAB battery requires bulk charging, it will get charged first until the point that it requires an absorb-stage charge. At that point the controller will effectively start reducing the current or “pulsing” it using Pulse Width Modulation PWM or some other means. Instead of simply dissipating the power between pulses, as is the case with conventional LAB battery systems, the excess power between LAB pulses will start getting injected into the LIB battery.

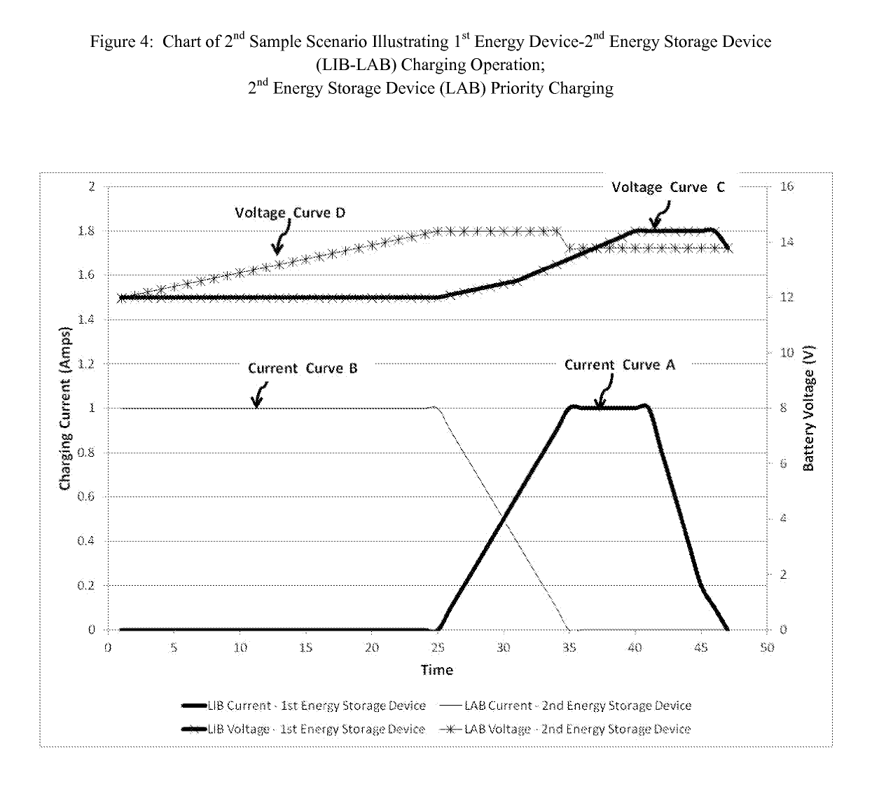

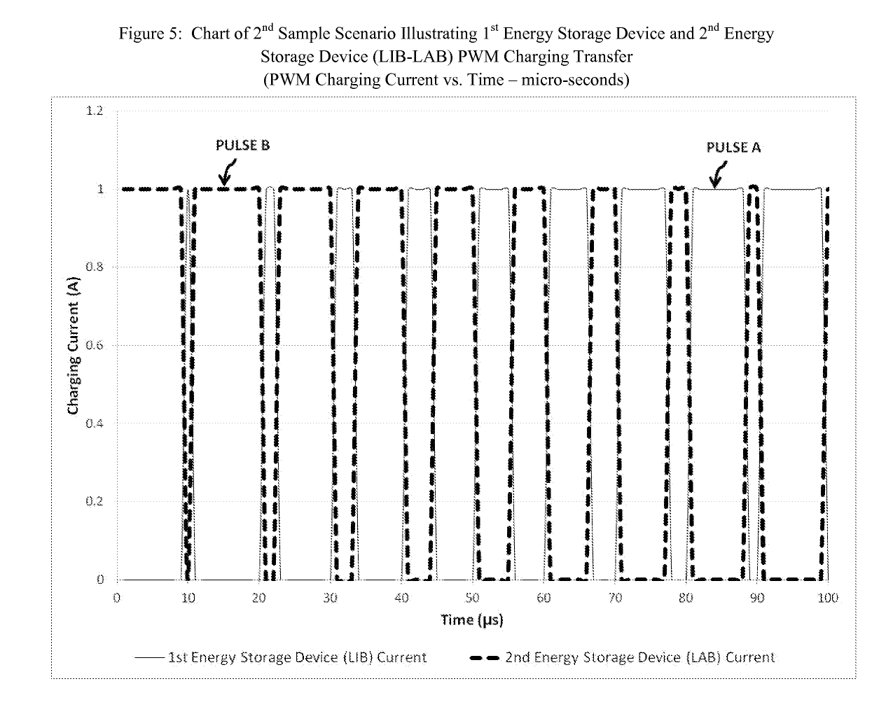

The chart in FIG. 4 above shows charging currents (Curves A and B, left hand scale) and voltages (Curves C and D, right hand scale) for both the 1^{st} Energy Storage Device (LIB) and 2^{nd} Energy Storage Device (LAB) batteries during a typical charging cycle. In this example the 2^{nd} Energy Storage Device (LAB) is charged first at the full available current of 1 amp (Curve B). When the voltage of the 2^{nd} Energy Storage Device (Curve D) reaches top of charge (typically 14.4V compensated for temperature) the controller switches to a constant voltage mode where it tapers the current to the 2^{nd} Energy Storage Device (Curve B) in order to maintain a constant voltage. Normally a charge controller throws away this energy because it is not needed. The controller outlined here will divert the excess energy to start charging the 1^{st} Energy Storage Device (LIB), so as the current to the 2^{nd} Energy Storage Device (LAB) tapers off, the current (Curve A) and voltage (Curve C) to the 1^{st} Energy Storage Device (LIB) increases. How this works is depicted in further detail in FIG. 5.

FIG. 5 above shows a method of PWM control for charging the 1^{st} Energy Storage Device (LIB) and 2^{nd} Energy Storage Device (LAB) simultaneously. This method is most effective when the LAB battery is near top of charge and must be held at a constant voltage. A PWM duty cycle is applied to the LAB charging current (Pulse B—dashed line). Varying the duty cycle controls the average current to the LAB. The controller monitors the LAB voltage and adjusts the control loop to find the average current to maintain the target voltage. During this time, rather than throw away the unneeded charging current, it is diverted to charge the LIB battery (Pulse A). As the LAB battery charges and requires less current, more current goes to charging the LIB battery. In this example, the PWM method shown is at 250 Hz but many other frequencies will work equally well.

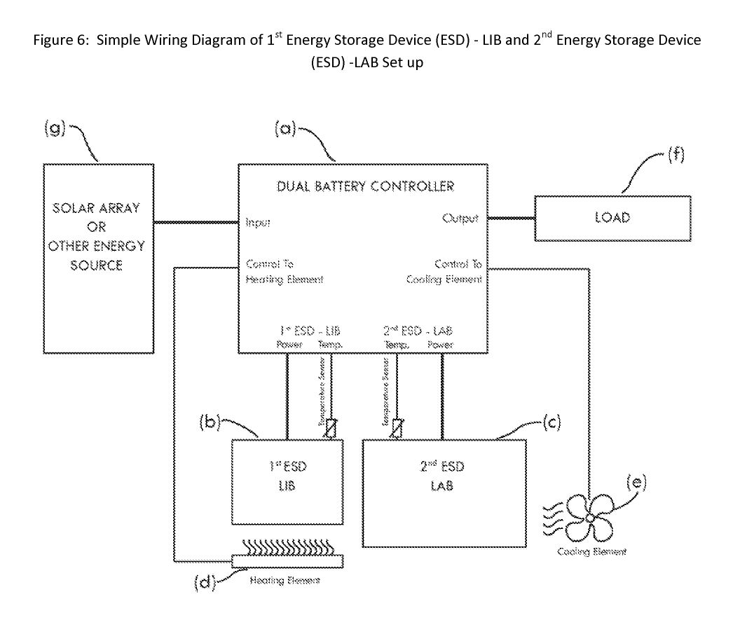

The simple wiring diagram in FIG. 6 is a basic representation of the LIB-LAB Combination system. The controller (a) receives power from an energy source (g) such as a solar array or wind generator and uses that power to charge the 1^{st} Energy Storage Device (b) and 2^{nd} Energy Storage Device (c). The Controller also draws energy from the energy storage devices to power the load (f). The controller (a) manages the combination battery charging algorithm. It does this based on information directly from the battery electric system (e.g. battery voltage, amp-hour counting) and temperature measurement devices. The controller will manage the characteristic of the charge going into the battery, (e.g. current level, voltage level) for each battery type. It may also take measures to improve the battery temperature for battery charging and increased battery life in certain cases. These measures might include using any excess solar power through an auxiliary circuit to power a cooling device (e) (e.g. fan, thermo-electric device) to reduce the LAB temperature when it gets over 25° C. or a heating element (d) for the LIB when it gets below 0° C. In this example the controller is shown to also manage the load (f) (e.g. camera, lighting, etc) and the battery charging source (e.g. solar). The controller load itself would be powered exclusively by (c) the 2^{nd} Energy Storage Device (LAB). The controller load is relatively small. The LAB is never drained to zero State of Charge (SOC)—so there is always some reserve capacity to power the basic functions and in general it simplifies the circuitry and software.

The controller would be built with several features that include:
maximizing charge to the batteries for their given state
ability to be programmed for application and conditions
managing the load for the given application
managing the charging and power draw from the batteries to best serve the application and preserve battery life
offering the potential to manage battery temperature with excess energy from solar panels or in reserve in battery.
providing appropriate diagnostics for each of the inputs and outputs as well as the controller itself.

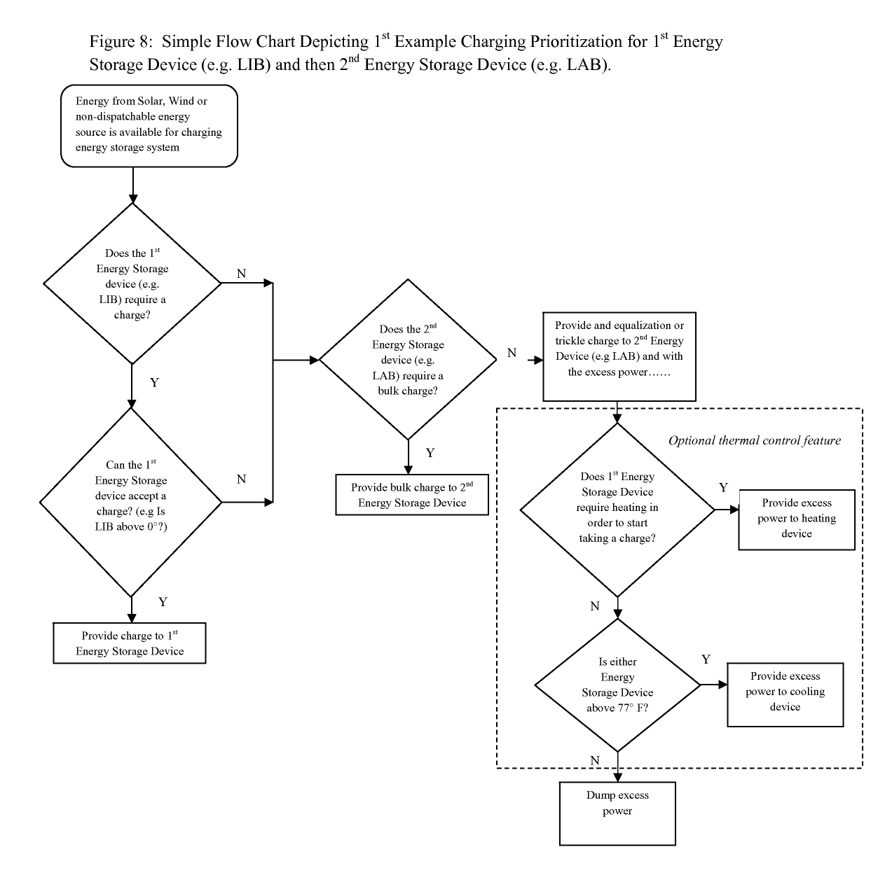

The controller must prioritize the charging of the two battery types according to the needs of the batteries and the existing conditions. The identified scheme of the first example gives priority to the 1^{st} Energy Storage Device (LIB), unless its temperature is below freezing, in which case the controller would seek to charge the 2^{nd} Energy Storage Device (LAB). If the LAB is fully charged then the system would seek to use some of the excess energy to power a heating element to the LIB. If the LIB is fully charged and its temperature is above freezing, then the controller will charge the LAB. If the LAB is charged then the controller will have the option to run a cooling fan to reduce the LAB temperature if its temperature is in excess of 25° C. If the power is not required, then ultimately it simply gets “dumped”. This scheme is depicted in the flow chart in FIG. 8.

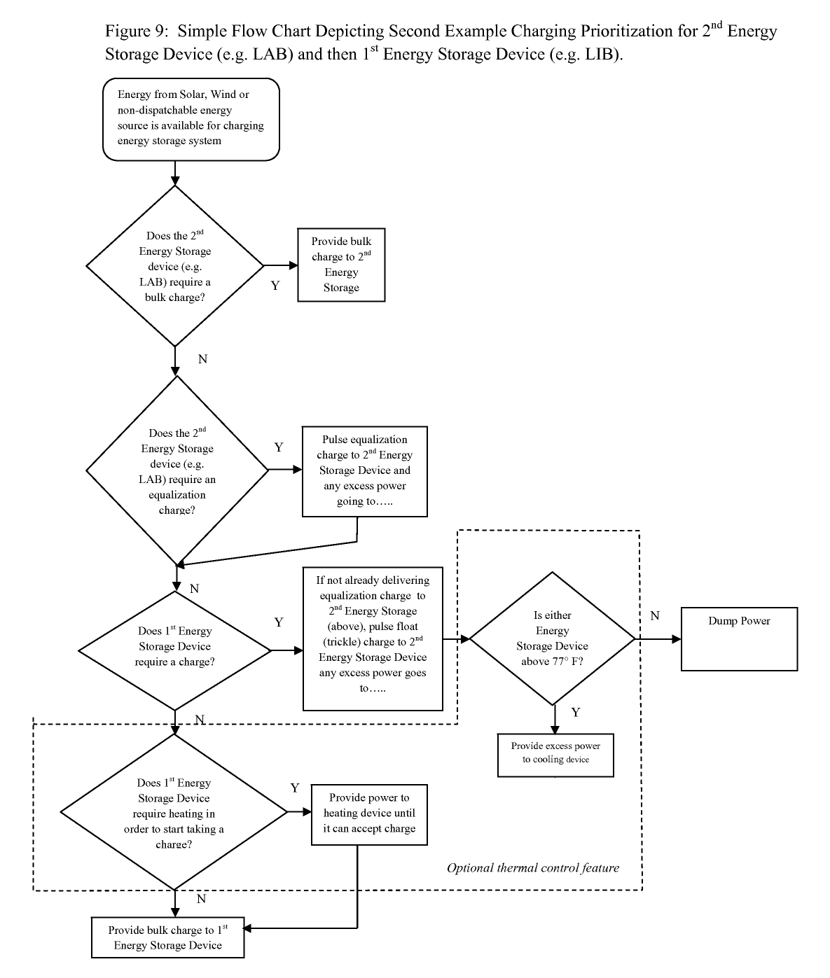

The identified scheme of the second example gives priority to the 2^{nd} Energy Storage Device (LAB). As mentioned previously, if the LAB battery requires a bulk charge, it receives the entire charge from the power source. If the LAB is at a higher state of charge and requires an equalization charge, it will start sharing its charge with the LIB system. At the point the LAB only requires a float or tickle charge, the LIB system receives the bulk of the charging. Meanwhile, if the 1^{st} Energy Storage Device (LIB) is below freezing, then any shared charge from the LAB system will go into running the LIB heating element (if it is offered with the system) to bring it above the freezing temperature. Otherwise the charge will go into charging the LIB. If both the LIB and LAB are fully charged then as in example 1, the controller will have the option to run a cooling fan to reduce the LAB temperature if its temperature is in excess of 25° C. If the power is not required, then ultimately it simply gets “dumped”. This scheme is depicted in the flow chart in FIG. 9.

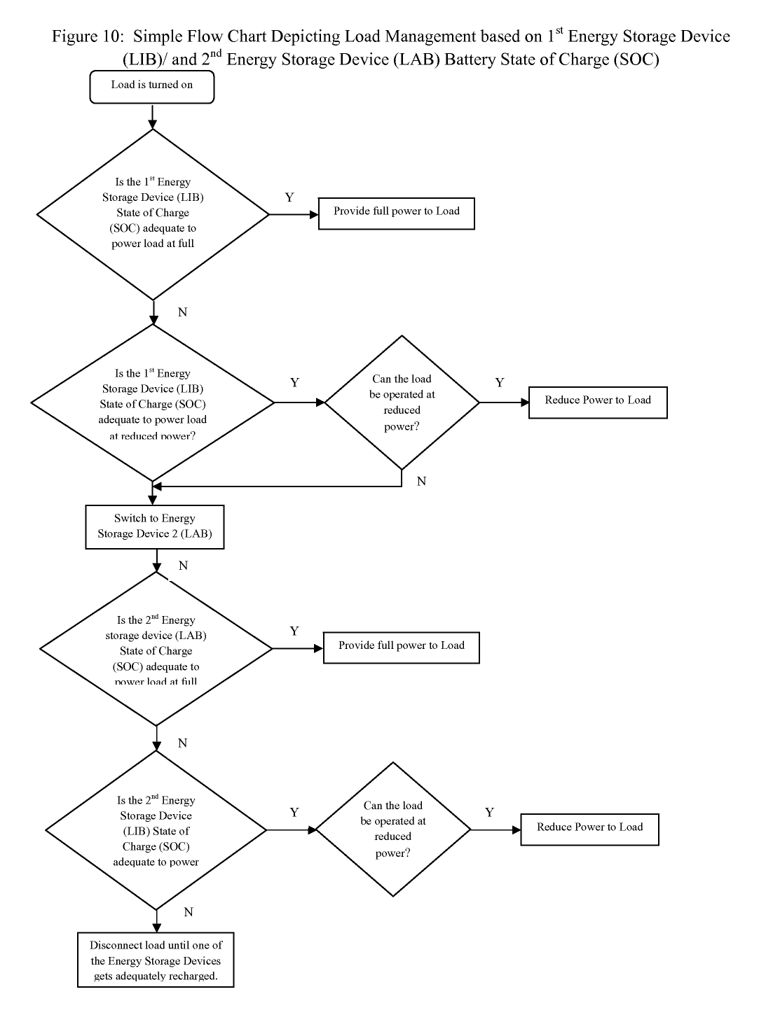

In a similar fashion the controller shall manage the load and switch from primary 1^{st} Energy Storage Device 1 (LIB) to 2^{nd} Energy Storage Device (LAB) in the event that the battery's State of Charge (SOC) reaches certain thresholds. In the example depicted in the simple flow chart of FIG. 10, if the 1^{st} Energy Storage Device (LIB) SOC is high, then it powers load at full power. If the 1^{st} Energy Storage Device capacity gets reduced to a certain critical level, then the load can be reduced to new, lower levels. If the LIB battery is fully depleted, then the system switches to the 2^{nd} Energy Storage Device (LAB) and the load can get switched to another reduced level(s). If the battery SOC continues to decline, then the load can continue to decline to additional levels until the point that the battery reaches a critical threshold that the load is disconnected from the battery, in order to preserve battery life.

### PRIOR ART

The following prior art was considered in this invention:
Rechargeable hybrid battery/supercapacitor system 6517972. Issued Jun. 26, 2001
Power supply control system for vehicle and method. Application Ser. No. 10/366,380 Publication number: US 2003/0160510 A1 Filing date: Feb. 14, 2003
US Patent Application: Pub. Nos: US 2009/0317696 A1 published Dec. 24, 2009 Compound battery device having Lithium Ion Battery and Lead Acid Battery

What is claimed is:

1) A compound energy storage sub-system having two types of energy storage devices (e.g. batteries) used in conjunction with a solar, wind, or other non-dispatchable energy source or combination thereof along with a control circuit to manage charging of the energy storage devices and serve a variable electric load. Wherein one energy storage device is capable of deep discharges from 60% to 100% for two to five thousand cycles within 70% of rated energy capacity and a second energy storage device, such as a deep cycle lead acid battery can only deliver on the order of five hundred to one thousand cycles within 70% of rated capacity at the same discharge levels, or similar cycle-life as the first storage device, but with discharges of only 10% to 30%. The control circuit shall employ pulse-width modulation (PWM) techniques in controlling the charge to the energy storage devices.

2) The control circuit can employ pulse-width modulation (PWM) as a technique to control the charge to the energy storage devices.

3) The control circuit in claim 1 manages the charging and discharging of each energy storage device independently.

4) The control circuit in claim 1 treats 1st energy storage device of claim 1 as primary energy storage device to serve average daily electrical load.

5) The control circuit in claim 1 treats the 2nd energy storage device of claim 1 as a reserve energy source to power more extreme electrical loads that are above and beyond average daily electrical load and occur only periodically.

6) The control circuit in claim 1 receives its power from the 2nd energy storage device in claim 1.

7) The control circuit of claim 1 will manage power to the load(s) so as to maintain a reserve capacity in the 2^{nd} energy storage device for powering the control circuit for extended periods of time (e.g 30 days) without receiving a charge.

8) The control circuit of claim 1 shall prioritize the charging of the two energy storage devices of claim 1 types according to the needs of the energy storage devices and the existing conditions.

9) One method for prioritizing charging of energy storage devices from claim 6 is to first determine if the 1st energy storage device is in need of a charge. If so, provide a charge to it first unless it is in a condition that prohibits the device from taking a charge. If the 1st energy device is fully charged, then provide the charge to the 2nd energy storage device.

10) Another method for prioritizing charging of energy storage devices from claim 6 could be used if the 2nd energy storage device is a deep cycle lead acid battery. In this case the control circuit in claim 1 would give priority charging to the 2nd energy storage device. The control circuit will share current with the 1st energy storage device depending on the type of charge required by lead acid battery (2nd energy storage device).

11) The control circuit of claim 1 can share charging current, as referenced in claim 8, by applying complementary pulses of energy to the 1st energy storage device when it is not delivering maximum current to the lead acid battery (2nd energy storage device).

12) The control circuit of claim 1 can deliver excess power from the energy sources in claim 1 that is not being used to directly charge the energy storage devices, to a thermal device that will heat up any storage device that is below a temperature where it can efficiently take a charge.

13) The control circuit of claim 1 can deliver excess power from the energy sources in claim 1 that is not being used to directly charge the energy storage devices, to a thermal device that can cool the storage devices at any point they are above 25° C. to extend cycle life.

14) For solar lighting applications, the aggregate rated capacity of the combination LIB-LAB energy storage system at 25° C. shall be between of 60% and 80% of a conventional LAB rated capacity sized for over 2,500 cycles at 25° C.

15) For solar lighting applications, the relative rated capacity of the 1^{st} Energy Storage Device (LIB) shall be between 20% and 40% of the aggregate rated capacity of the combination LIB-LAB energy storage system at 25° C. The balance of the rated capacity is provided by the 2^{nd} Energy Storage Device (LAB).
